(19) United States
(12) Patent Application Publication
(10) Pub. No.: US 2024/0302610 A1
(43) Pub. Date: Sep. 12, 2024

(54) METHOD FOR CONNECTING OPTICAL WAVEGUIDE, AND OPTICAL WAVEGUIDE CONNECTION STRUCTURE

(71) Applicant: Panasonic Intellectual Property Management Co., Ltd., Osaka (JP)

(72) Inventors: JUNICHI KAMATANI, Nara (JP); TATSURO SHIRAISHI, Osaka (JP)

(21) Appl. No.: 18/665,619

(22) Filed: May 16, 2024

Related U.S. Application Data
(63) Continuation of application No. PCT/JP2022/039855, filed on Oct. 26, 2022.

(30) Foreign Application Priority Data
Nov. 26, 2021 (JP) 2021-192459

(51) Int. Cl. G02B 6/42

(52) U.S. Cl. CPC G02B 6/4239

(57) ABSTRACT

A method for connecting an optical waveguide includes: adjusting an inclination of an optical fiber block with respect to substrate (10), the optical fiber block including through-passage (34), and the substrate including spacer (60) surrounding light input part (12), by holding and bringing optical fiber block (20) into contact with the spacer, and then releasing the optical fiber block; supplying adhesive (70) to outside of the spacer on the substrate; aligning the optical fiber block holding an optical fiber, with respect to the light input part, to maximize intensity of light output from the substrate; compressing the spacer by pushing the optical fiber block including the through-passage toward the substrate; and curing the adhesive, with the spacer compressed.

### TECHNICAL FIELD

The present disclosure relates to a method for connecting an optical waveguide, and an optical waveguide connection structure.

### BACKGROUND ART

In recent years, utilization of light has been explored in the fields of high-speed communication, large-capacity communication, and sensing. In particular, a technology called “silicon photonics” has been attracting attention. Silicon photonics is a technology for forming an optical circuit on a silicon substrate using a complementary metal oxide semiconductor (CMOS) process, in the same manner as for semiconductor electronic circuits. Optical circuits fabricated by silicon photonics are microscopic circuits with a light control function. Elements such as light input/output units and an optical modulator are implemented on an optical circuit. These elements are connected to one another using an extremely fine optical waveguide, which is in the order of submicron. In order to connect an external transfer medium such as an optical fiber to the optical waveguide at a high precision, efforts for developing various types of optical interface are being made actively.

In general, as a method for connecting an optical fiber to an optical waveguide on a substrate (that is, for establishing a fiber-to-chip coupling), a method for using adhesive has been used. With this method, an end face of a light input part, which is formed on the substrate, is bonded and fixed to the entire end face of an optical fiber block where one or more optical fibers are bundled, via an adhesive.

In a configuration in which the optical fiber block is fixed to the substrate using this approach, the laser light output from the optical fibers to the light input part, which is on the substrate, passes through the adhesive layer, which is interposed between the optical fiber and the substrate. Because the adhesive layer becomes chemically modified by laser light, the amount of laser light becoming incident on the optical waveguide becomes reduced. In other words, such an optical circuit suffers from coupling loss. Coupling loss is known to increases over time from when the laser light is output, and, when the laser light is high power, the coupling loss can persist over time.

Therefore, it is necessary to couple the optical fiber block to the substrate without disposing adhesive between the optical fiber and the substrate, that is, without disposing any adhesive at the position where the laser light passes.

However, even if the adhesive is applied only to the side surfaces of the optical fiber block to fix the optical fiber block to the substrate, the adhesive creeps into the interface between the optical fiber block and the substrate, due to the capillary phenomenon, and reaches between the optical fiber and the substrate.

Patent Literature 1 discloses providing stopper grooves in the optical fiber block or the substrate so as to prevent adhesive from getting between the optical fiber and the substrate. Such stopper grooves are positioned on both sides of the optical fibers, with the optical fibers therebetween, and extend in directions perpendicular to the direction in which the optical fibers are arranged, and perpendicular to the direction in which the light travels.

### CITATION LIST

### Patent Literature

PTL 1: Unexamined Japanese Patent Publication No. 2017-54110

### SUMMARY OF THE INVENTION

A method for connecting an optical waveguide according to one aspect of the present disclosure includes: providing a substrate including a spacer having a frame shape surrounding a light input part, holding an optical fiber block and bringing the optical fiber block into contact with the spacer, and then releasing the optical fiber block; supplying an adhesive on an outer side of the spacer on the substrate; aligning the optical fiber block holding an optical fiber, with respect to the light input part, to maximize intensity of light output from the substrate; compressing the spacer by pushing the optical fiber block, toward the substrate; and curing the adhesive, with the spacer compressed.

An optical waveguide connection structure according to an aspect of the present disclosure is a connection structure that uses an adhesive to connect a substrate including at least one optical waveguide and a light input part, to an optical fiber block holding an optical fiber, the optical waveguide connection structure including a spacer having a frame shape and provided between the substrate and the optical fiber block in a manner surrounding the light input part provided on the substrate.

### BRIEF DESCRIPTION OF THE DRAWINGS

FIG. 1 is a cross-sectional view schematically illustrating an optical waveguide connection structure according to an exemplary embodiment of the present disclosure, taken along a YZ plane.

FIG. 2 is a plan view illustrating a substrate of the optical waveguide connection structure according to the exemplary embodiment of the present disclosure.

FIG. 3 is an exploded perspective view illustrating an optical fiber block of the optical waveguide connection structure according to the exemplary embodiment of the present disclosure.

FIG. 4 is a flowchart illustrating method for connecting an optical waveguide, according to the exemplary embodiment of the present disclosure.

FIG. 5A is a diagram for explaining how inclination of the optical fiber block is adjusted.

FIG. 5B is a diagram for explaining how inclination of the optical fiber block is adjusted.

FIG. 6 is an XZ cross-sectional view of the optical waveguide connection structure before a spacer is compressed.

FIG. 7 is an XZ cross-sectional view of the optical waveguide connection structure after the spacer is compressed.

### DESCRIPTION OF EMBODIMENT

In the conventional technique disclosed in Patent Literature 1, when the adhesive is less viscous, the adhesive may creep into and over the stopper grooves, so it is difficult to completely prevent the adhesive from getting between the optical fiber and the substrate. Furthermore, if an optical fiber block, with a very slight inclination, is moved closer to the substrate, the optical fiber block may cause a damage and generate particles, and may result in an increase in the coupling loss.

An object of a non-limiting embodiment of the present disclosure is to provide a method for connecting an optical waveguide, and an optical waveguide connection structure capable of preventing entry of an adhesive into a part where light passes, using a simple structure, capable of suppressing an increase in the coupling loss over time, and capable of preventing the optical fiber block from being brought into contact with the substrate even when the optical fiber block with a very slight inclination is moved closer to the substrate.

Preferred exemplary embodiments of the present disclosure will now be explained in detail with reference to drawings. In the description herein and the drawings, elements provided with substantially the same functions are denoted by the same reference numerals, and redundant explanations thereof will be omitted. The shape, thickness, length, or the like of element members illustrated in the drawings described below are different from those of the actual component members. Furthermore, the materials of such component members are not limited to those described in the present exemplary embodiment.

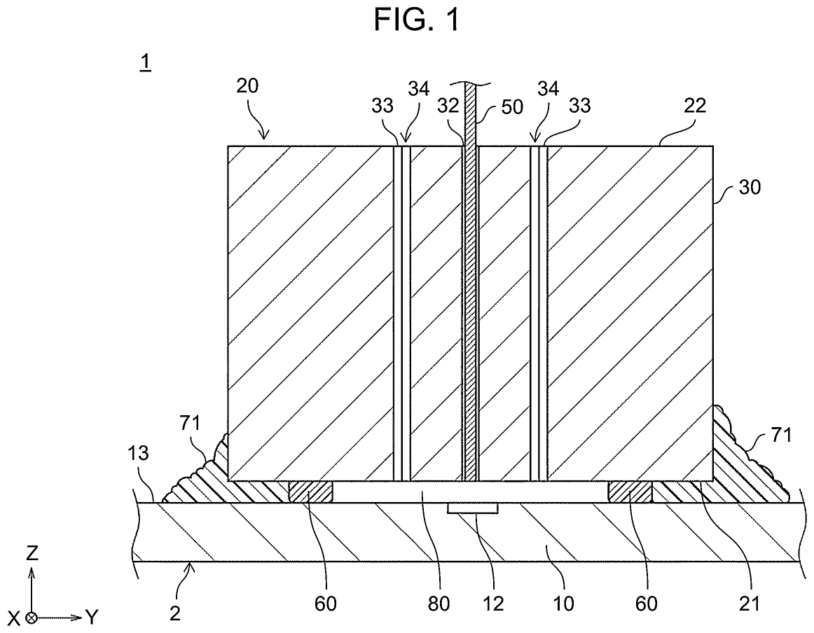

In FIGS. 1 to 7, an X-axis direction, a Y-axis direction, and a Z-axis direction represent a direction parallel to the X-axis, a direction parallel to the Y-axis, and a direction parallel to the Z-axis, respectively. The X-axis direction and the Y-axis direction are orthogonal to each other. The X-axis direction and the Z-axis direction are orthogonal to each other. The Y-axis direction and the Z-axis direction are orthogonal to each other. An XY plane represents a virtual plane extending in parallel with the X-axis direction and the Y-axis direction. An XZ plane represents a virtual plane extending parallel with the X-axis direction and the Z-axis direction. The YZ plane represents a virtual plane extending parallel with the Y-axis direction and the Z-axis direction. In FIGS. 1 to 7, the direction to which an arrow points in the X-axis direction corresponds to a positive X-axis direction, and a direction opposite to the direction corresponds to a negative X-axis direction. In FIGS. 1 to 7, the direction to which an arrow points in the Y-axis direction corresponds to a positive Y-axis direction, and a direction opposite to the direction corresponds to a negative Y-axis direction. In FIGS. 1 to 7, the direction to which an arrow points in the Z-axis direction corresponds to a positive Z-axis direction, and a direction opposite to the direction corresponds to a negative Z-axis direction. The Z-axis direction is equivalent of a vertical direction or an up-down direction, for example, and the X-axis direction and the Y-axis direction are equivalent of horizontal directions or right-left directions, for example.

### EXEMPLARY EMBODIMENT

### <Optical Waveguide Connection Structure>

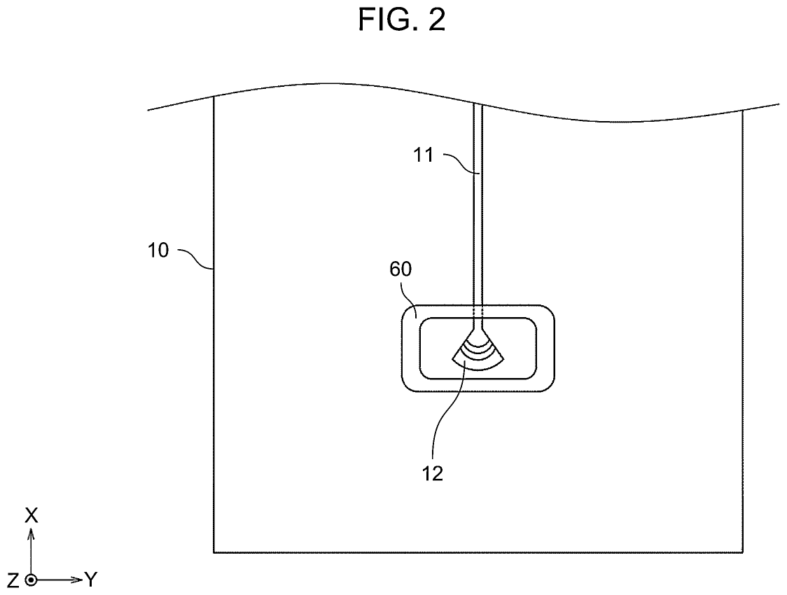

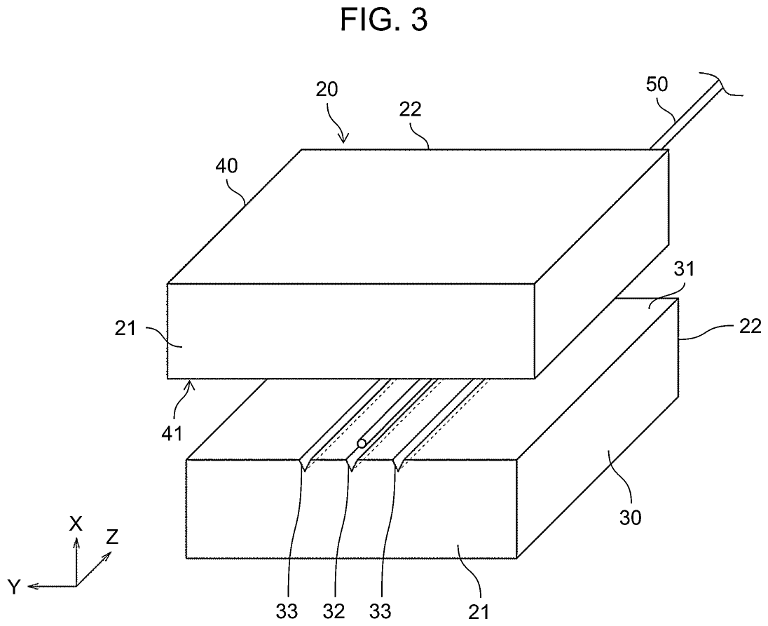

To begin with, optical waveguide connection structure 1 according to an exemplary embodiment of the present disclosure will be explained with reference to FIGS. 1, 2, and 3. FIG. 1 is a cross-sectional view schematically illustrating optical waveguide connection structure 1 according to an exemplary embodiment of the present disclosure, taken along a YZ plane. FIG. 2 is a plan view illustrating substrate 10 in optical waveguide connection structure 1 according to the exemplary embodiment of the present disclosure, and FIG. 3 is an exploded perspective view illustrating optical fiber block 20 in optical waveguide connection structure 1 according to the exemplary embodiment of the present disclosure. Optical waveguide connection structure 1 is a mounting substrate implemented using a method for connecting an optical waveguide, which is to be described later.

Optical waveguide connection structure 1 includes substrate 10, optical fiber block 20, and adhesive layer 71.

As illustrated in FIG. 2, substrate 10 includes optical waveguide 11, light input part 12, and spacer 60. Optical waveguide 11 has a plate-like structure for propagating the light from light input part 12 to light output part, not illustrated. An example of light input part 12 is a grating coupler (that is, a diffractive grating optical coupler). Optical waveguide 11 and light input part 12 are formed by photolithographic patterning, for example. Substrate 10 is formed of a substance such as quartz or silicon, for example.

On front surface 13 of substrate 10, a frame-shaped spacer 60 is provided in a manner surrounding light input part 12.

Spacer 60 is an elastically deformable member. Spacer 60 not only controls the distance between optical fiber 50 and light input part 12 in the Z direction, but also prevents adhesive layer 71 from flowing into the interface between optical fiber 50 and light input part 12, and prevents optical fiber block 20 and substrate 10 from coming into direct contact with each other. The elastic modulus of the elastic material of spacer 60 is defined by applying a force to the material, and dividing the force by the resultant strain. The elastic modulus of spacer 60 is lower than the elastic moduli of optical fiber block 20 and of substrate 10. The deformation rate of spacer 60 in the direction perpendicular to front surface 13 of substrate 10 (that is, in the Z direction) is greater than the deformation rates of optical fiber block 20 and of substrate 10 in the same perpendicular direction. The compressive elasticity modulus of spacer 60 is 500 kgf/mm², for example.

Spacer 60 has an external dimension smaller than the external dimension of opposing face 21 of optical fiber block 20, and is disposed on front surface 13 of substrate 10, in a frame shape, e.g., an annular shape, in a manner surrounding the periphery of light input part 12, on the outer side with respect to the positions of respective through-passages 34, which are on opposing face 21 of optical fiber block 20. Spacer 60 only may have any shape as long as the shape is a one-continuous frame shape, and may be a linear shape or a curved shape in a view from the Z direction, for example. Spacer 60 is disposed so that a surface facing the side of opposing face 21 of optical fiber block 20 extend in parallel with front surface 13 of substrate 10.

The size of spacer 60 in the Z direction is larger than the size of adhesive 70 applied to front surface 13 of substrate 10, in the Z direction. Therefore, when optical fiber block 20 is brought closer to substrate 10, optical fiber block 20 is at first brought into contact with spacer 60. Hence, optical fiber block 20 and substrate 10 are not brought into contact with each other. The size of spacer 60 in the Z direction is 5 μm, for example. Note that the size of spacer 60 in the Z direction is not limited thereto, and may be 10 μm or 50 μm, for example, depending on a desirable distance between optical fiber 50 and light input part 12 in optical waveguide connection structure 1.

The width of spacer 60 is less than or equal to 10 μm, for example.

Spacer 60 is formed using a photosensitive resin, for example, by using a technique such as photolithographic patterning, so as to surround light input part 12 highly precisely on substrate 10.

Note that the method for fabricating spacer 60 is not limited thereto, and for example, spacer 60 may be fabricated by combining and arranging a plurality of plate-like members in a frame shape on front surface 13 of substrate 10, on the outer side of through-passages 34 that is on opposing face 21 of optical fiber block 20, in such a manner that light input part 12 is surrounded by spacer 60, and that the external dimension of spacer 60 is smaller than the external dimension of opposing face 21 of optical fiber block 20.

Optical fiber block 20 is a component for inputting light to light input part 12, and holds optical fiber 50. Optical fiber block 20 is fixed to substrate 10, with adhesive layer 71 and spacer 60 therebetween.

Optical fiber block 20 has opposing face 21 and face 22. Opposing face 21 is a surface facing front surface 13 of the substrate 10. Opposing face 21 of optical fiber block 20 is polished using a method such as chemical mechanical polishing (CMP). The reason for polishing opposing face 21 is to ensure parallelity of opposing face 21 with respect to with front surface 13 of substrate 10 at the time when optical fiber block 20 is inclined in a process of ensuring that the light is emitted from optical fiber 50 becomes incident on light input part 12 at a predetermined angle. Face 22 is a surface on the opposite side of opposing face 21 of optical fiber block 20.

As illustrated in FIG. 3, optical fiber block 20 includes holder 30 having opposing face 21 and face 22, and lid 40 having opposing face 21 and face 22.

Holder 30 has a substantially rectangular parallelepiped plate-like shape, and is a member having installation groove 32 and two grooves 33 on face 31.

Each of installation groove 32 and grooves 33 has a triangular notch-like cross section. Installation groove 32 and two grooves 33 are arranged in a line in parallel with each other, and extend from opposing face 21 to face 22 of holder 30.

Installation groove 32 interposed between the two grooves 33 is a groove for holding optical fiber 50. The number of installation grooves 32 is not limited to one, and a plurality of installation grooves may be provided, depending on the configuration of light input part 12.

Grooves 33 are grooves forming through-passages 34 via which air layer 80 is connected with the external space. At least one groove 33 is provided to holder 30.

Each of installation groove 32 and grooves 33 has a shape in which the width of the groove becomes smaller toward the bottom of the groove, for example. In the present exemplary embodiment, each of installation groove 32 and grooves 33 have a shape forming a triangular notch on opposing face 21 of holder 30.

Installation groove 32 and groove 33 have a depth of 1 μm or more. One side surface of each of installation groove 32 and groove 33 and another side surface of installation groove 32 and groove 33 facing the one side surface forms an opening at an angle of one degree or more and less than 180 degrees.

Installation groove 32 and grooves 33 are formed on face 31 of holder 30 using a technique such as cutting, or photolithographic patterning.

Each of installation groove 32 and grooves 33 may have a shape with a bottom delineating a straight line, or a shape with a bottom delineating a curve, in a view facing opposing face 21.

Holder 30 is formed of a material such as quartz or silicon.

Lid 40 has a substantially rectangular parallelepiped plate-like shape, and is a member for holding optical fiber 50 with holder 30. Face 41 in FIG. 3 is a face of lid 40 on the side facing holder 30. When face 41 of lid 40 on the side facing holder 30 is aligned with face 31 of holder 30, lid 40 and holder 30 can hold optical fiber 50 therebetween. At this time, holder 30, lid 40, and optical fiber 50 may be fixed using an adhesive, not illustrated, for fixing. Lid 40 is formed of a substance such as quartz or silicon.

As illustrated in FIG. 1, optical fiber block 20 has through-passages 34 that are formed by the plurality of respective grooves 33 on holder 30 and face 41 of lid 40. In the present exemplary embodiment, through-passages 34 penetrate through holder 30, from opposing face 21 to face 22. Through-passages 34 are holes used for creating air layer 80.

Optical fiber 50 is a medium that transmits light, and examples of which include a single mode fiber, a multi-mode fiber, a quartz fiber, and a plastic fiber. Optical fiber 50 is disposed in a manner penetrating through optical fiber block 20.

Adhesive layer 71 is a layer formed by curing adhesive 70 disposed on front surface 13 of substrate 10, around optical fiber block 20. Adhesive layer 71 fixes optical fiber block 20 to substrate 10. A component of adhesive 70 include a photocurable or thermosetting resin such as an acrylic resin, an epoxy resin, an acrylic epoxy resin, or a silicon resin.

Inside a space surrounded by spacer 60, air layer 80 is formed between optical fiber block 20 and light input part 12 of substrate 10. Air layer 80 is connected to the external space via through-passages 34. With this structure, optical fiber 50 and optical fiber block 20 are connected to substrate 10, with air layer 80 therebetween.

Air layer 80 may be formed of dry air using through-passage 34, or may be formed of nitrogen, argon, or a mixture gas thereof. In such a configuration, ends of respective through-passages 34 on the side facing face 22 are sealed with resin, for example.

### <Method for Connecting Optical Waveguide>

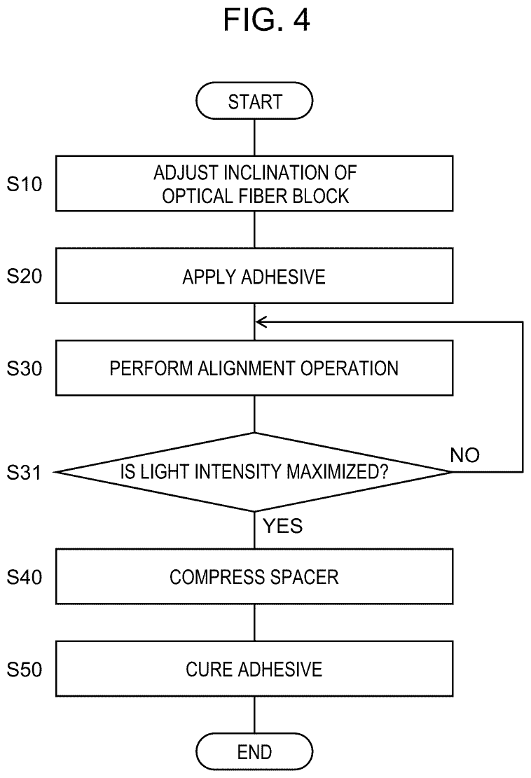

A method for connecting an optical waveguide according to an exemplary embodiment of the present disclosure will now be explained with reference to FIG. 4. FIG. 4 is a flowchart illustrating a method for connecting an optical waveguide, according to the exemplary embodiment of the present disclosure.

To begin with, inclination of optical fiber block 20 is adjusted (step S10). Adjusting the inclination of optical fiber block 20 means bringing an angle formed by opposing face 21 of optical fiber block 20 and front surface 13 of substrate 10 closer to 0 degrees.

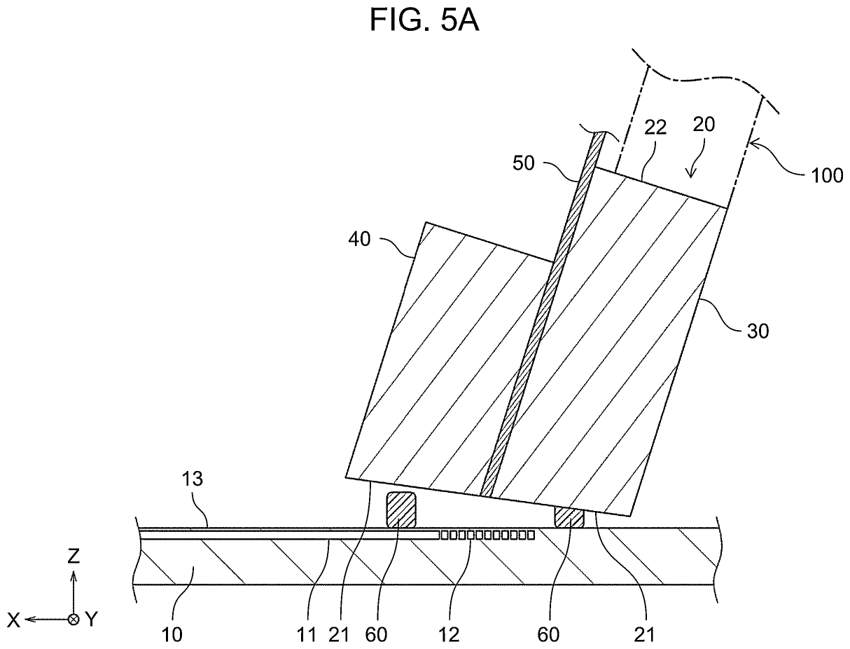

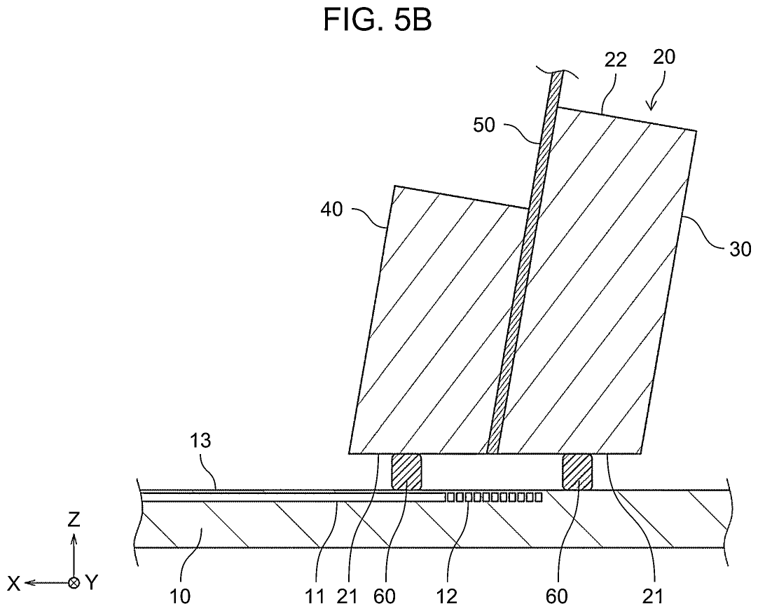

FIGS. 5A and 5B are diagrams for explaining how inclination of optical fiber block 20 is adjusted.

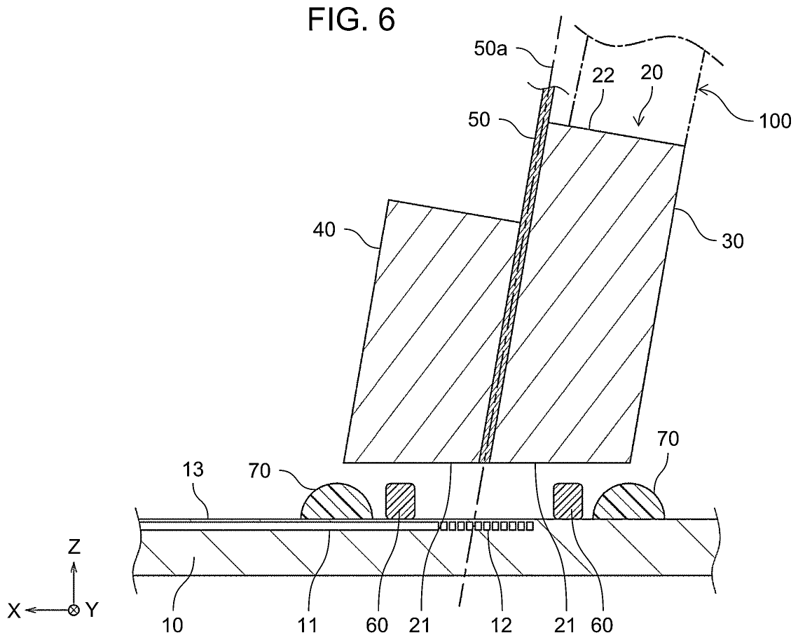

In step S10, to begin with, optical fiber block 20 is moved closer to substrate 10, by holding optical fiber block 20. Optical fiber block 20 then comes into contact with spacer 60 on front surface 13 of substrate 10. Even when optical fiber block 20 is inclined with respect to front surface 13 of substrate 10, as illustrated in FIG. 5A, spacer 60 prevents optical fiber block 20 from coming into direct contact with substrate 10. By releasing optical fiber block 20, with optical fiber block 20 in contact with spacer 60, opposing face 21 of optical fiber block 20 is settled in parallel with spacer 60, as illustrated in FIG. 5B. Therefore, the angle formed by opposing face 21 of optical fiber block 20 and front surface 13 of substrate 10 can be brought closer to 0 degrees. After the inclination of optical fiber block 20 is adjusted, optical fiber block 20 is held again, and lifted in the Z direction for the next step S20 (see FIG. 6).

To hold optical fiber block 20, a member having a suction hole and suction device 100 is used to suctioning optical fiber block 20 through the suction hole, so that optical fiber block 20 can be held and released easily.

To bring optical fiber block 20 closer to substrate 10 (to adjust optical fiber block 20), it is possible to use the holding member described above in combination with a linear motion stage that uses a linear ball guide, for example, and a gonio stage. The reason for using a plurality of stages in combination is to enable adjustments of optical fiber block 20 with respect to a plurality of axes, in an alignment operation, which will be described later.

Next, adhesive 70 is supplied on the outer side of spacer 60 of substrate 10 (step S20).

FIG. 6 is an XZ cross-sectional view of optical waveguide connection structure 1 before spacer 60 is compressed. In step S20, adhesive 70 is supplied by applying adhesive 70 on the outer side of spacer 60 in a manner surrounding the entire periphery of spacer 60, by a size smaller in the Z direction, than the size of spacer 60 in Z direction. Adhesive 70 thus applied is blocked by spacer 60, so that adhesive 70 does not go inside of spacer 60 and onto light input part 12. Adhesive 70 is not limited to one surrounding the entire periphery of spacer 60, on the outer side of spacer 60, and may be disposed intermittently, on the outer side of spacer 60, as long as optical fiber block 20 and substrate 10 are fixed with adhesive 70.

Adhesive 70 is applied using a dispenser, for example. To connect one optical waveguide, adhesive is supplied by an amount of 1 nL or more and 1000 μL or less, for example.

Next, an alignment operation for aligning optical fiber block 20 to light input part 12 is performed (step S30). The alignment operation is an operation for moving optical fiber block 20 to a predetermined position in the XY plane with respect to light input part 12. The predetermined position is a position of optical fiber block 20 in the XY plane where the intensity of the light output from light output part, not illustrated, on substrate 10 is maximized, the light being output in response to the light becoming incident on light input part 12 via optical fiber 50. By moving optical fiber block 20 to a predetermined position, optical axis 50a of optical fiber block 20 is aligned with respect to light input part 12.

Next, it is determined whether the intensity of the light output from the light output part, not illustrated, on substrate 10 has been maximized, while changing and adjusting the position of optical fiber block 20 (step S31). In other words, in step S30 and next step S31, the position of optical fiber block 20 is adjusted, and the optical axis 50a of optical fiber block 20 is aligned with respect to light input part 12 in such a manner that the intensity of light emitted from the light output part, not illustrated, on substrate 10 is maximized, the light being emitted in response to the light becoming incident on light input part 12 via optical fiber 50.

If the intensity of the light output from the light output part, not illustrated, on substrate 10 has not been maximized (NO in step S31), step S30 is repeated until the intensity of the light is maximized. In other words, while changing and adjusting the position of optical fiber block 20, the intensity of the light output from the light output part, not illustrated, provided on substrate 10 is measured at each position, to look for the position where the measured intensity is maximized.

The position of optical fiber block 20 may be adjusted by using the holding member in combination with a linear motion stage that uses a linear ball guide, for example, and a gonio stage. When only a linear motion stage using a linear ball guide is combined with the holding member, it is possible to move optical fiber block 20 in directions along three axes that are orthogonal to each other. When a gonio stage is further combined, it is possible not only to move optical fiber block 20 in the three axial directions, but also to tilt optical fiber block 20 about the three axes. In this manner, the position and posture of optical fiber block 20 can be adjusted in any directions.

The intensity of the light is measured by, for example, receiving the light output from the light output part, not illustrated, on substrate 10 using an optical fiber, and outputting the received light to a photodetector. The position where the light is received may be adjusted by combining a holding member, a linear motion stage that uses a linear ball guide, for example, and a gonio stage.

Note that alignment of the optical axis of optical fiber block 20 adjusted by the operation in step S30 is at a precision in the order of nanometers. The operation in step S30 may also be performed to achieve alignment at a precision in the order of micrometers.

If the intensity of the light output from the light output part, not illustrated, on substrate 10 has been maximized (YES in step S31), optical fiber block 20 is moved closer to substrate 10 so as to push and to compress spacer 60 toward the substrate (step S40).

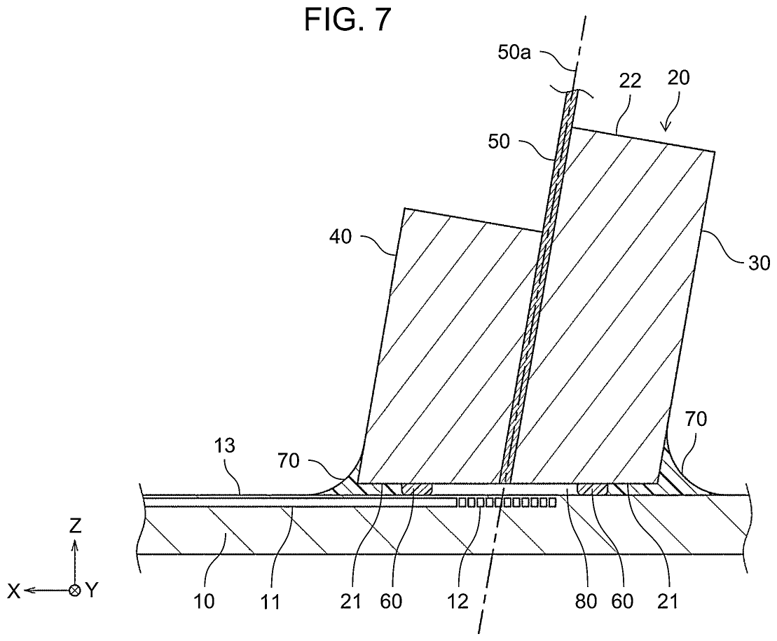

FIG. 7 is an XZ cross-sectional view of optical waveguide connection structure 1 after spacer 60 is compressed. When optical fiber block 20 is moved closer to substrate 10 and optical fiber block 20 comes into contact with spacer 60, spacer 60 elastically deforms and becomes compressed by receiving the force. Because spacer 60 has an elastic modulus lower than those of optical fiber block 20 and substrate 10, spacer 60 is compressed and deformed between optical fiber block 20 and substrate 10.

When optical fiber block 20 is brought closer to substrate 10, optical fiber block 20 is brought closer along optical axis 50a of optical fiber block 20, for example. The reason for bringing the optical fiber block 20 closer to substrate 10 along the optical axis 50a is that, if optical fiber block 20 is moved only in the Z direction, optical axis 50a having been already aligned with respect to light input part 12 would become out of alignment in the X-axis direction. In summary, spacer 60 is compressed by moving optical fiber block 20 in the X-axis direction to a position where the alignment optical axis 50a of optical fiber block 20 with respect to light input part 12, the alignment having been achieved in advance, remains the same even after spacer 60 is compressed, and by applying a force to optical fiber block 20 in the Z direction.

In step S40, because the size of spacer 60 in the Z direction is larger than the size of adhesive 70 in the Z direction, optical fiber block 20 at first comes into contact with spacer 60, so that adhesive 70 does not goes into spacer 60 and light input part 12.

Even after optical fiber block 20 comes into contact with spacer 60, optical fiber block 20 is moved closer to the light input part 12 at a predetermined force, by applying the force to optical fiber block 20 toward light input part 12 along the optical axis direction of optical fiber block 20, to compress spacer 60 further. In this manner, it is possible to make the distance between opposing face 21 of optical fiber block 20 and light input part 12 in the Z direction uniform. At this time, because optical fiber block 20 has through-passages 34, the internal space of spacer 60 does not become sealed. The distance between opposing face 21 of optical fiber block 20 and light input part 12 in the Z direction, with spacer 60 compressed, is 1 nm or more and 5 μm or less. The predetermined force is a force required to achieve such a distance between opposing face 21 of optical fiber block 20 and light input part 12 in the Z direction by compressing spacer 60, and is determined depending on the size of uncompressed spacer 60 and the amount of dimensional deformation in the Z direction, and is 1 Pa or more and 1 MPa or less, for example.

Next, adhesive 70 is cured, with spacer 60 compressed (step S50). In step S50, adhesive 70 is irradiated with ultraviolet rays, or the ambient temperature is raised. As a result, adhesive 70 becomes cured, to form adhesive layer 71. With this, optical fiber block 20 is fixed to substrate 10. It is possible to cure adhesive 70 using a light source that emits ultraviolet rays, or a high-temperature furnace, for example.

Through the steps described above, optical waveguide connection structure 1 illustrated in FIG. 1 is achieved.

As described above, in the connection of optical waveguide 11, because spacer 60 is formed on substrate 10, adhesive layer 71 does not get into light input part 12. Optical fiber block 20 have through-passages 34 connecting the space inside spacer 60 to external space so that the space is not sealed, that the space inside spacer 60 can be easily compressed without any resistance, and optical fiber block 20 and adhesive layer 71 on substrate 10 can come into contact with each other. In this manner, optical fiber block 20 and substrate 10 are fixed via adhesive layer 71, but optical fiber 50 and light input part 12 are not connected via adhesive layer 71. Therefore, with simple structures of substrate 10 having spacer 60 and optical fiber block 20 having through-passages 34, spacer 60 can prevent adhesive layer 71 from getting into the space between optical fiber 50 and light input part 12, in the connection of optical waveguide 11. As a result, it is possible to suppress an increase in the coupling loss over time in optical waveguide connection structure 1. In addition, even when slightly inclined optical fiber block 20 is moved closer to substrate 10, spacer 60 can prevent optical fiber block 20 from coming into contact with substrate 10.

Optical fiber block 20 and substrate 10 are fixed by mainly connecting the side surface of optical fiber block 20 and front surface 13 of substrate 10 with adhesive layer 71 via spacer 60. Therefore, optical fiber block 20 can be fixed firmly to substrate 10, while suppressing an increase in coupling loss over time, in optical waveguide connection structure 1.

Although the present disclosure has been fully described in connection with a preferable exemplary embodiment with reference to the accompanying drawings, various modifications and corrections are obvious to those skilled in the art. Such variations and modifications are to be understood as being included within the scope of the present disclosure as set forth in the appended scope of claims, as long as such variations and modifications do not depart from the scope of the present disclosure. In addition, changes in the combination and the order of elements in the exemplary embodiment can be achieved without departing from the scope and ideas of the present disclosure.

Note that, by combining any of the exemplary embodiments and modifications thereof described above as appropriate, it is possible to achieve the effects thereof. Combination of exemplary embodiments, combination of examples, or combination of exemplary embodiments and examples are possible, and combination of features in different exemplary embodiments or examples are also possible.

According to the present disclosure, it is possible to provide a method for connecting an optical waveguide and an optical waveguide connection structure capable of preventing an adhesive layer from getting between an optical fiber and a light input part, with a simple configuration of a substrate having a spacer and an optical fiber block, capable of suppressing a temporal increase in coupling loss over time, and capable of preventing contact between the optical fiber block and the substrate with the spacer, even when the optical fiber block with a very slight inclination is moved closer to the substrate.

### INDUSTRIAL APPLICABILITY

An embodiment of the present disclosure can be suitably used in a method for connecting an optical waveguide and an optical waveguide connection structure. In addition, the method for connecting an optical waveguide and the optical waveguide connection structure according to the above aspect of the present disclosure can permanently connect the optical fiber block and the optical circuit board while suppressing a temporal coupling loss, and thus can be applied to fields such as high-speed optical communication, representative examples of which are silicon photonics and high-precision sensing using laser light.

### REFERENCE MARKS IN THE DRAWINGS

1 optical waveguide connection structure
10 substrate
11 optical waveguide
12 light input part
13 front surface
20 optical fiber block
21 opposing face
22 face
30 holder
31 face
32 installation groove
33 groove
34 through-passage
40 lid
41 face
50 optical fiber
50a optical axis
60 spacer
70 adhesive
71 adhesive layer
80 air layer
100 suction device

1. A method for connecting an optical waveguide, the method comprising:
providing a substrate including a spacer having a frame shape surrounding a light input part, holding an optical fiber block and bringing the optical fiber block into contact with the spacer, and then releasing the optical fiber block;
supplying an adhesive on an outer side of the spacer on the substrate;
aligning the optical fiber block holding an optical fiber, with respect to the light input part, to maximize intensity of light output from the substrate;
compressing the spacer by pushing the optical fiber block, toward the substrate; and
curing the adhesive, with the spacer compressed.

2. The method according to claim 1, wherein, the supplying adhesive includes applying the adhesive on the outer side of the spacer by a size smaller in a Z direction than a size of the spacer in the Z direction.

3. The method according to claim 1, wherein, the compressing the spacer includes applying a force to the light input part in a direction of an optical axis of the optical fiber block.

4. The method according to claim 1, wherein, the compressing the spacer includes:
moving the optical fiber block in an X-axis direction to a position where alignment of an optical axis of the optical fiber block with respect to the light input part, the alignment having been achieved in advance, remains same, even after the spacer compressed, and
applying a force in the Z direction.

5. The method according to claim 1, wherein, the optical fiber block includes a through passage that connects an internal space to an external space, the internal space being surrounded by the spacer, the optical fiber block, and the substrate to an external space via the through-passage provided in the optical fiber block.

6. An optical waveguide connection structure that uses an adhesive to connect a substrate including at least one optical waveguide and a light input part, to an optical fiber block holding an optical fiber, the optical waveguide connection structure comprising a spacer having a frame shape and provided between the substrate and the optical fiber block in a manner surrounding the light input part provided on the substrate.

7. The optical waveguide connection structure according to claim 6, wherein the spacer has an external dimension smaller than an external dimension of a face of the optical fiber block, the face facing the substrate, and the spacer is disposed on an outer side with respect to a through-passage that is on the face of the optical fiber block facing the substrate.

8. The optical waveguide connection structure according to claim 6, wherein the spacer has an elastic modulus lower than an elastic modulus of the optical fiber block and an elastic modulus of the substrate.

9. The optical waveguide connection structure according to claim 6, wherein the spacer has a deformation rate lower than a deformation rate of the optical fiber block and a deformation rate of the substrate.
